(19) United States
(12) Patent Application Publication
(10) Pub. No.: US 2002/0145700 A1
(43) Pub. Date: Oct. 10, 2002

(54) Projection display apparatus

(76) Inventor: Motoo Takahashi, Tokyo (JP)

Correspondence Address: BIRCH STEWART KOLASCH & BIRCH, PO BOX 747, FALLS CHURCH, VA, 22040-0747, US

(21) Appl. No.: 09/962,447

(22) Filed: Sep. 26, 2001

(30) Foreign Application Priority Data
Apr. 5, 2001 (JP) 106970/01

(51) Int. Cl. G02F 1/13

(52) U.S. Cl. 349/199

(57) ABSTRACT

A projection display apparatus including an optical system having a lens for projecting a light emitted from a light source onto a screen and a cooler having an exhaust fan for cooling the light source is disclosed. The projection display apparatus includes a light receiver for receiving a light reflected from the screen, a first controller for controlling a quantity of the light emitted from the light source in accordance with an intensity of the light received by the light receiver, a heat sensor for sensing a heat given off from the light source, and a second controller for controlling a volume of air exhausted by the exhaust fan per unit time in accordance with a quantity of the heat sensed by the heat sensor.

### FIELD OF THE INVENTION

The present invention relates to a projection display apparatus such as an LC (Liquid Crystal) projector having a liquid crystal panel used as a light valve.

### BACKGROUND OF THE INVENTION

Projection display apparatuses including LC projectors are being put to use with growing frequency for displaying characters, tables, diagrams as well as television pictures for a presentation in a corporation, a lesson in a school, information in public facilities and so forth.

On the other hand, the need of miniaturizing such projection display apparatuses and also enhancing the performance of their light sources to obtain brighter and finer projected images is growing in recent years. Halogen lamps have been used as the light sources of the projection display apparatus. The halogen lamp is easy to handle since its output is stable, and it does not need any glow switch. However, the halogen lamp has several disadvantages. For example, it cannot emit the light in sufficient quantity since the light comes out of a filament which is supplied with a current to glow, and its luminous efficiency is low. In addition, the halogen lamp has a short life. Therefore, it is difficult to accommodate the above-described need with respect to the light source of the projection display apparatus by using the halogen lamp.

Accordingly, a high-voltage discharge tube, notably a small-sized metal halide lamp of the short arc type which has advantages of large emission of light, high luminous efficiency, long life, and outstanding color rendering characteristic is replacing the halogen lamp in recent years.

### OBJECT AND SUMMARY OF THE INVENTION

However, the life of the high-voltage discharge tube or the metal halide lamp is not long enough (about 2000 to 4000 hours) either, and therefore using the high-discharge tube as the light source does not save the trouble of replacing a dead lamp with a new one. In addition, to use such a lamp emitting large quantity of light, some air-admitting device has to be provided for stabilizing the quantity of the light and preventing the lamp from bursting or collapsing. Since the volume of the air required for cooling the lamp per unit time increases as the quantity of the light emitted from the lamp increases, the noise caused by the air-admitting device increases with the increase of the quantity of the light as well.

Incidentally, there are various types of screen which the light from the light source is projected onto. FIG. 5 shows screen gain versus viewing angle characteristics for various types of screen. FIG. 6 shows reflection characteristics of a diffusion type screen (white type), a return type screen (bead type), a reflection type screen (pearl/silver type). From FIGS. 5 and 6, it is apparent that the optical characteristics of a screen depend on the material and the surface form of the screen.

If a screen having a high screen gain is used, it is possible to reduce the quantity of the light emitted from the light source by reducing the power supplied to the light source, since an image formed on the screen is luminous enough. Furthermore, the volume of the air to be admitted for cooling the lamp by the air-admitting device can be reduced as well in that case.

An object of the present invention, which has been made taking notice that luminance of a projected image depends on the optical property of a screen in use, is to increase the life of the lamp and reduce the noise caused by the air-admitting device in the projection display apparatus.

The above-described object can be achieved by a projection display apparatus including an optical system having a lens for projecting a light emitted from a light source onto a screen and a cooler having an exhaust fan for cooling the light source; the projection display apparatus comprising:

a light receiver for receiving a light reflected from the screen;

a first controller for controlling a quantity of the light emitted from the light source in accordance with an intensity of the light received by the light receiver;

a heat sensor for sensing a heat given off from the light source; and

a second controller for controlling a volume of air exhausted by the exhaust fan per unit time in accordance with a quantity of the heat sensed by the heat sensor.

The first controller may control a power supplied to the light source in accordance with the intensity of the light received by the light receiver.

The second controller may control the volume of air exhausted by the exhaust fan per unit time in accordance with a temperature in the neighborhood of the light source.

### BRIEF DESCRIPTION OF THE DRAWINGS

An embodiment of the invention will now be described by way of example and with reference to the accompanying drawings in which:

FIG. 1 is a block diagram showing a structure of one example of the projection display apparatus according to the invention;

FIG. 2 is a view for explaining how the projection display apparatus according to the invention is used;

FIG. 3 is a view showing a remote controller used for starting the projection display apparatus according to the invention;

FIG. 4 is a view showing a structure of a cooler included in the projection display apparatus according to the invention;

FIG. 5 is a graph showing screen gain versus viewing angle characteristics for various types of screen; and

FIG. 6 is a view showing reflection characteristics of a diffusion type screen (white type), a return type screen (bead type), and a reflection type screen (pearl/silver type).

### DESCRIPTION OF THE PREFERRED EMBODIMENT

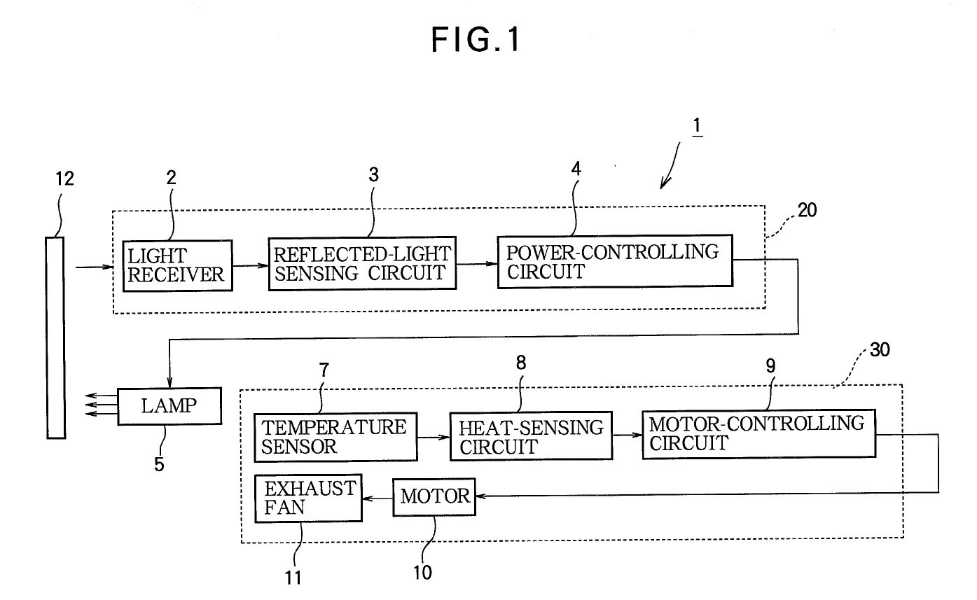

FIG. 1 is a block diagram showing a structure of one example of the projection display apparatus according to the invention. In FIG. 1, 5 denotes a lamp or a high-voltage discharge tube such as a metal halide lamp, 20 denotes a light-quantity controller for controlling quantity of the light emitted from the lamp 5, and 30 denotes a cooler for cooling the lamp 5.

The light-quantity controller 20 includes a light receiver 2, a reflected-light sensing circuit 3, and a power-controlling circuit 4. The cooler 30 includes a temperature sensor 7, a heat-sensing circuit 8, a motor-controlling circuit 9, a motor 10, and an exhaust fan 11. The projection display apparatus 1 also includes an optical system comprised of a light valve such as a liquid crystal panel, a magnifying lens, etc. however, it is omitted from illustration, since it has not immediate connection with the present invention.

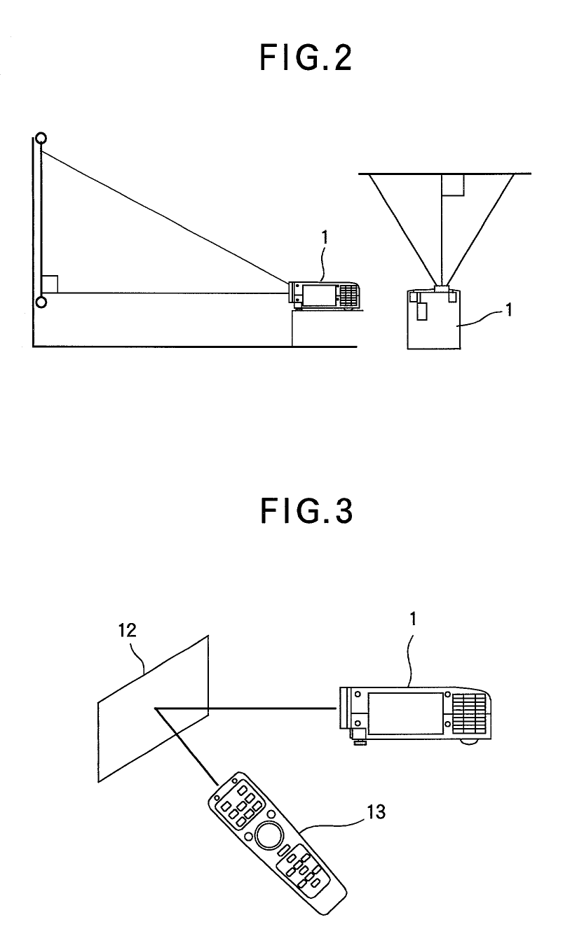

As shown in FIG. 2, the projection display apparatus 1 is put on a table or the like and starts to run when a switch (not shown) mounted on the apparatus is pressed for projecting the light from the lamp 5 onto a screen 12 thereby forming an image on the screen.

As shown in FIG. 3, it is also possible to start the projection display apparatus 1 by pressing a switch of a remote controller 13 to irradiate the screen 12 with infrared light, and by detecting the infrared light reflected from the screen 12 by the light receiver 2.

The operation of the light-quantity controller 20 of the projection display apparatus 1 will be described below. The light emitted from the lamp 5 passes a not illustrated light valve such-as a liquid crystal panel, and is magnified by a lens of a not illustrated optical system to be projected onto the screen 12. The light receiver 2 receives a part of the light reflected from the screen 12. The reflected-light sensing circuit 3 determines the intensity of the light received by the light receiver 2, and sends a signal indicative of the determined intensity to the power-controlling circuit 4. The power-controlling circuit 4 controls the power supplied to the lamp 5 automatically in accordance with this signal.

As has been explained, the optical characteristics of a screen depend on its type, and luminance of a projected image and intensity of the light received by the light receiver 2 depend on the screen gain of the screen. Accordingly, when the intensity of the light received by the light receiver 2 is high, the reflected-light sensing circuit 3 can conclude that the quantity of the light emitted from the lamp 5 can be reduced assuming that the screen gain of the screen 12 is high and therefore the luminance of the image is high enough. In this case, the reflected-light sensing circuit 3 sends a signal to the power-controlling circuit 4 to reduce the power supplied to the lamp 5. On the other hand, when the intensity of the light received by the light receiver 2 is low, the reflected-light sensing circuit 3 concludes that the quantity of the light emitted from the lamp 5 has to be increased assuming that the screen gain of the screen 12 is low and therefore the luminance of the image is low.

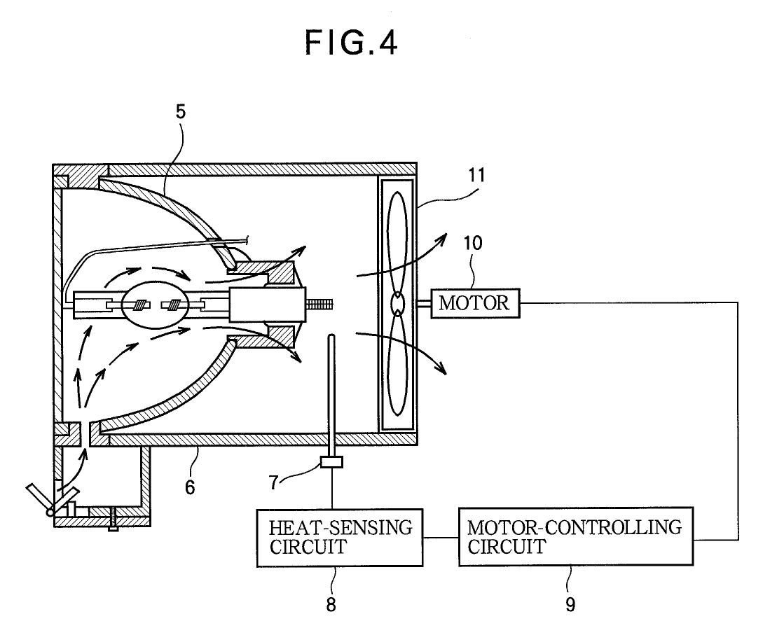

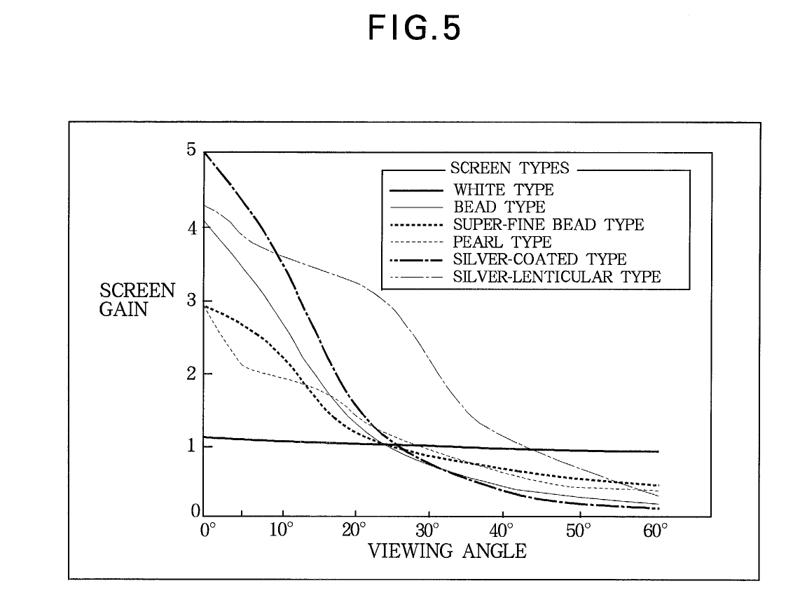

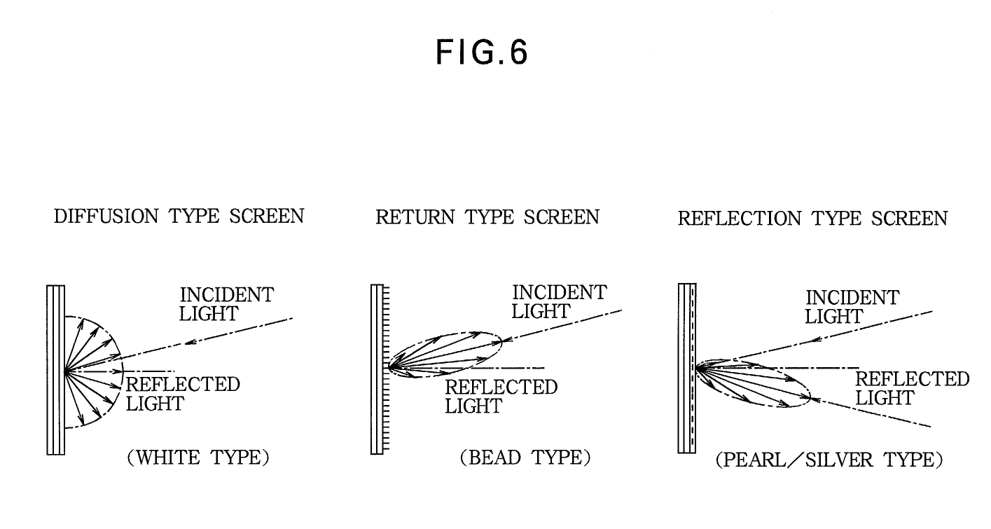

When the power supplied to the lamp 5 is changed as a result of the above-described power control operation, the heat given off from the lamp 5 is changed and accordingly the temperature in the neighborhood of the lamp 5 is changed. The cooler 30 changes automatically the volume of the air admitted per unit time in accordance with the change of this temperature. FIG. 4 shows a structure of the cooler 30. As can be seen from FIG. 4, since the lamp 5 is encased in a housing 6, the exhaust fan 11 produces a flow of air along the arrows to exhaust the heat from the housing 6. The temperature sensor 7 is used for measuring the temperature in the neighborhood of the lamp 5. The heat-sensing circuit 8 sends a signal having a value in accordance with the temperature measured by the temperature sensor 7 to the motor-controlling circuit 9. The motor-controlling circuit 9 controls the rotation speed of the motor 10, that is, the rotation speed of the exhaust fan 11 on the basis of this signal.

If the power supplied to the lamp 5 is reduced as a result of the control by the power-controlling circuit 4, the heat given off from the lamp 5 is reduced, and therefore, the temperature measured by the temperature sensor 7 falls. In this case, the heat-sensing circuit 8 concludes that the heat given off from the lamp 5 has reduced, so the volume of the air for cooling the lamp 5 can be reduced, and then sends a signal to the motor-controlling circuit 9 to reduce the rotation speed of the motor 10. On the other hand, If the power supplied to the lamp 5 is increased as a result of the control by the power-controlling circuit 4, the heat given off from the lamp 5 increases and therefore, the temperature measured by the temperature sensor 7 rises. In this case, the heat-sensing circuit 8 concludes that the heat given off from the lamp 5 has increased, so the volume of the air for cooling the lamp 5 has to be increased, and then sends a signal to the motor-controlling circuit 9 to increase the rotation speed of the motor 10. It is also possible to control the rotation speed of the motor 10 on the basis of the value of the power supplied to the lamp 5 instead of the value of the temperature measured by the temperature sensor 7.

With the above-described projection display apparatus of the invention, it is possible to keep luminance of a projected image constant irrespective of the optical property of the screen in use and a cumulative total of hours of use of the display apparatus, since the power supplied to the lamp 5 and the rotation speed of the exhaust fan 11 are automatically controlled in accordance with the intensity of the light reflected from the screen. Furthermore, since the output of the lamp 5 and the rotation speed of the exhaust fan 11 are automatically reduced when the screen has a high screen gain and therefore the intensity of the light reflected from the screen is high, the life of the lamp 5 is increased and the noise caused by the exhaust fan 11 are reduced accordingly.

The above explained preferred embodiments are exemplary of the invention of the present application which is described solely by the claims appended below. It should be understood that modifications of the preferred embodiments may be made as would occur to one of skill in the art.

claims:

1. A projection display apparatus including an optical system having a lens for projecting a light emitted from a light source onto a screen and a cooler having an exhaust fan for cooling said light source; said projection display apparatus comprising:
a light receiver for receiving a light reflected from said screen;
a first controller for controlling a quantity of the light emitted from said light source in accordance with an intensity of the light received by said light receiver;
a heat sensor for sensing a heat given off from said light source; and
a second controller for controlling a volume of air exhausted by said exhaust fan per unit time in accordance with a quantity of the heat sensed by said heat sensor.

2. A projection display apparatus according to claim 1, in which said first controller controls a power supplied to said light source in accordance with the intensity of the light received by said light receiver.

3. A projection display apparatus according to claim 1, in which said second controller controls the volume of air exhausted by said exhaust fan per unit time in accordance with a temperature in the neighborhood of said light source.
